(19) United States
(12) Patent Application Publication
(10) Pub. No.: US 2025/0328606 A1
(43) Pub. Date: Oct. 23, 2025

(54) DRM AND OTT DATA AND STREAMING CONCURRENCY VALIDATION

(71) Applicant: DISH Network Technologies India Private Limited, Bengaluru, Karnataka (IN)

(72) Inventors: Lohit Huddar, Bengaluru (IN); Sagar Sehgal, Bengaluru (IN); Nitin Gupta, Bangalore (IN); Chinmay Hegde, Bengaluru (IN)

(21) Appl. No.: 18/642,179

(22) Filed: Apr. 22, 2024

(51) Int. Cl. G06F 21/10

(52) U.S. Cl. CPC G06F 21/10

(57) ABSTRACT

A method may include receiving a request for streaming video data from a user device. The request may include an identifier associated with the user device. The method may include validating the request. The method may include storing the identifier associated with the user device, and/or a property associated with the request. The method may include transmitting a playlist to the user device, identifying one or more data segments. The method may include receiving a DRM request. The DRM request may include the identifier associated with the user device and an identifier corresponding to a first data segment of the playlist. The method may include validating the DRM request. The method may include providing a key to the user device such that the user device may decrypt the first data segment.

### BACKGROUND

Streaming video requires data segments to be delivered to a user device in order to play the streaming video. The data segments may be encrypted and require a digital rights management (DRM) key to be requested and received for some or all of the data segments. The DRM key, however, may be at least partially visible if the DRM request and/or the DRM key is intercepted or viewed. The DRM key may then be published, along with the data segment(s), and unauthorized users may gain access to the streaming video.

### BRIEF SUMMARY

A method of validating a streaming video request may include receiving, by a computing system, a request for streaming video data from a user device. The request may include an identifier associated with the user device. The method may include validating, by the computing system, the request utilizing the identifier associated with the user device. The method may include storing, by the computing system, the identifier associated with the user device, a property associated with the request for the streaming video data, or any combination thereof. In response to validating the user device, the method may include transmitting, by the computing system, a playlist to the user device, the playlist identifying one or more data segments of the streaming video data. The method may include receiving, by the computing system, a digital rights management (DRM) request. The DRM request may include the identifier associated with the user device and an identifier corresponding to a first data segment of the one or more data segments of the playlist. The method may include validating, by the computing system, the DRM request based at least in part on the identifier associated with the user device, the request for streaming video data, the identifier corresponding to the first data segment, or any combination thereof. In response to validating the DRM request, the method may include providing, by the computing system, a key to the user device such that the user device may decrypt the first data segment.

In some embodiments, the identifier corresponding to the first data segment may include a uniform resource locator (URL), the URL configured to be a one-time use URL. The identifier corresponding to the respective portion of the data may include a uniform resource locator (URL), where the URL may include a timestamp indicating a time a request the first data segment was transmitted. The property associated with the streaming video data may include an access policy associated with the data based on at least one of geographical data, an account level, or a concurrent device limit. The property associated with the request for the streaming video data may include a timestamp indicating a time the request was transmitted. The identifier associated with the user device include at least one of an IP address or a mac address.

In some embodiments, the method may include receiving, by the computing system, a second DRM request. The second DRM request may include the identifier associated with the user device and an identifier corresponding to a second data segment of the one or more data segments of the playlist. The method may include validating, by the computing system, the second DRM request based at least in part on the identifier associated with the user device, the request for streaming video data, the identifier corresponding to the second data segment, or any combination thereof. In response to validating the DRM request, the method may include providing, by the computing system, a second key to the user device such that the user device decrypts the second data segment. The DRM request may include a URL and the identifier associated with the user device is comprised in a header of the DRM request.

In some embodiments, the method may include receiving, by the computing system, a second request for the streaming video data. The second request may include the identifier associated with the user device. The method may include determining, by the computing system, that the second request is invalid based at least in part on the identifier associated with the user device, the property associated with the request for the streaming video data, the property associated with the streaming video data, or any combination thereof. The method may include transmitting, by the computing system, a failure message to a sender of the second request for the streaming video data.

A system may include a manifest generator configured to generate a playlist of one or more data segments, the playlist of data segments may include a respective URL for each of the data segments, where each of the data segments may include a portion of streaming video data. The system may include a concurrency service may include one or more access policies associated with the data segments. The system may include a digital rights management (DRM) service configured to generate keys to decrypt one or more of the data segments. The system may include one or more processors. The system may include a non-transitory computer readable memory including instructions that, when executed by the one or more processors, cause the system to perform operations to receive, by the manifest generator, a request for streaming video data from a user device. The request may include an identifier associated with the user device. The system may validate, by at least one of the manifest generator or the concurrency service, the request utilizing the identifier associated with the user device. The system may store, by the concurrency service, the identifier associated with the user device, a property associated with the request for the streaming video data, or any combination thereof. In response to validating the user device, the system may transmit, by the manifest generator, a playlist to the user device, the playlist identifying one or more data segments of the streaming video data. The system may receive, by the DRM service, a DRM request. The DRM request may include the identifier associated with the user device and an identifier corresponding to a first data segment of the one or more data segments of the playlist. The system may validate, by at least one of the DRM service or the concurrency service, the DRM request based at least in part on the identifier associated with the user device, the request for streaming video data, the identifier corresponding to the first data segment, or any combination thereof. In response to validating the DRM request, the system may provide a key to the user device such that the user device may decrypt the first data segment.

In some embodiments, the DRM service may be associated with at least one of a media provider, a content provider, or a third-party. The identifier corresponding to the first data segment may include a uniform resource locator (URL), the URL configured to be a one-time use URL. The URL may include an encrypted count such that the URL is unique. The key may be associated with the first data segment. The key may be associated with a plurality of data segments, the plurality of data segments including the first data segment. The DRM request may include a URL and the identifier associated with the user device may be included in a header of the DRM request. The identifier associated with the user device includes at least one of an IP address or a mac address.

A non-transitory computer-readable medium may include instructions that, when executed by one or more processors, cause the one or more processors to perform operations. The operations may include receiving, by a computing system, a request for streaming video data from a user device. The request may include an identifier associated with the user device. The operations may include validating, by the computing system, the request utilizing the identifier associated with the user device. The operations may include storing, by the computing system, the identifier associated with the user device, a property associated with the request for the streaming video data, or any combination thereof. In response to validating the user device, the operations may include transmitting, by the computing system, a playlist to the user device, the playlist identifying one or more data segments of the streaming video data. The operations may include receiving, by the computing system, a digital rights management (DRM) request. The DRM request may include the identifier associated with the user device and an identifier corresponding to a first data segment of the one or more data segments of the playlist. The operations may include validating, by the computing system, the DRM request based at least in part on the identifier associated with the user device, the request for streaming video data, the identifier corresponding to the first data segment, or any combination thereof. In response to validating the DRM request, the operations may include providing, by the computing system, a key to the user device such that the user device may decrypt the first data segment.

In some embodiments, the key may be associated with the first data segment. The key may be associated with a plurality of data segments, the plurality of data segments including the first data segment.

### BRIEF DESCRIPTION OF THE DRAWINGS

FIG. 1 illustrates a system and a process for validating a media file request, according to certain embodiments.

FIG. 2 illustrates a system for generating a playlist, according to certain embodiments.

FIG. 3 illustrates a system for receiving a data segment, according to certain embodiments.

FIG. 4 illustrates a system for providing a DRM key, according to certain embodiments.

FIG. 5 illustrates a system for decrypting a data segment, according to certain embodiments.

FIG. 6 illustrates a flowchart of a method for validating a streaming video request, according to certain embodiments.

### DETAILED DESCRIPTION

Piracy and unauthorized access to content has long been a concern of content providers. Over the air and cable television may be recorded using devices such as VCRs and other equipment. Providing a full video for offline viewing may present its own challenges, as once the file(s) is on a user device, a content provider may have little to no control over what happens to the file(s) afterwards. While streaming video may have become a common way for users to access content, streaming may present further challenges in protecting content from being accessed without the proper permission.

For example, as opposed to other schemas for delivering content, streaming video such as internet-based television, on-demand video, and other such streaming services may include multiple providers in order to provide the streaming video. An internet video provider may handle user account-related tasks, such as user device validation, account permissions, digital rights management (DRM), and other such tasks. The internet video provider may the provide access to a content provider with an associated content delivery network (CDN). The content provider may provide access to the associated CDN to users of the internet video provider, relying on the internet television provider to control access to their content (i.e., prevent piracy, etc.). The internet video provider may therefore be responsible for ensuring that any access policies set by the content provider are followed, and that unauthorized access to the content provider's content is minimized.

In order to provide streaming video, multiple data segments of a streaming video may be provided to the user device. Once the internet video provider validates the user device, the user device may be provided with a manifest identifying data segments making up the requested video stream. The user device may then request the data segments directly from the CDN. Each of the data segments may be encrypted with a DRM key and transmitted to the user device in order. user device may request the DRM key from the internet video provider to decrypt each of the data segments. Typically, however, validation of the user device may occur prior to the manifest being provided to the user device. In other words, there may be no further validation of the user device after the manifest is provided and the DRM key may be provided to any user device that can provide a proper request to the CDN for any particular data segment. In some cases, the DRM key may also be discoverable by widely available tools such as developer mode in web browsers etc. A bad actor may make a valid request for a manifest for a particular video stream, copy the manifest, and, upon receiving the DRM key, copy the DRM key. The manifest and the DRM key may then be published or otherwise given out, and unauthorized users may access the content. Thus, there is a need to provide better DRM protection for streaming video in order to minimize unauthorized access.

One solution may be to include a concurrency service to validate requests for manifests (sometimes “playlists”), requests for data segments, and/or DRM requests. A user may request a media file(s) (e.g., to display a streaming video) via an application running on a user device such as a mobile device, tablet, computer, set top box, or other such device. The request may include user credentials (e.g., an account identifier), an identifier associated with the user device, and other such information. The request may be received by a media provider service and the user credentials and/or user device may be authenticated by the media provider service. An entry may be created in a concurrency service, indicating that the user device (and/or a user account) sent the request for the media file(s). The concurrency service may also determine whether or not the user device and/or user account has requested and/or received the media file(s) before or recently.

Upon validating the request, the user account, and/or the user device, the media provider service may then transmit a manifest (or playlist) to the user device. The manifest may identify one or more data segments associated with the media file(s) requested by the user. Each of the data segments may include a respective uniform resource locator (URL). Each respective URL may be a one time use URL. The user device may then send a request including the respective URL for a first data segment to a content delivery network (CDN) associated with the media file(s). The CDN may then transmit an encrypted data segment corresponding to the first data segment to the user device. The user device may then transmit a digital rights management (DRM) request to a DRM service using the respective URL associated with the first data segment. The DRM service may then determine whether the respective URL or another URL associated with the same media file(s) has been used by the user device and/or user account by communicating with the concurrency service. If the concurrency service responds that the DRM request is valid (e.g., the user account, the user device, etc. has not made the same request before or recently), the DRM service may transmit a key to the user device so that the first data segment may be decrypted and displayed. If the concurrency service indicates that the DRM request is invalid, the DRM service may transmit an error message to the user device.

Because the DRM service may check with the concurrency service before providing the DRM key to the user device, the DRM service may determine whether or not the user requesting the DRM key is authorized to access the first data segment before transmitting the key. This may provide enhanced DRM protection by not only limiting the number of copies of the data segments that are sent out by the CDN (e.g., with a one-time use URL), but by performing a second check before transmitting the DRM key. Even if a bad actor requested and received a data segment, the request for the DRM key may be rejected, based on the check with the concurrency service.

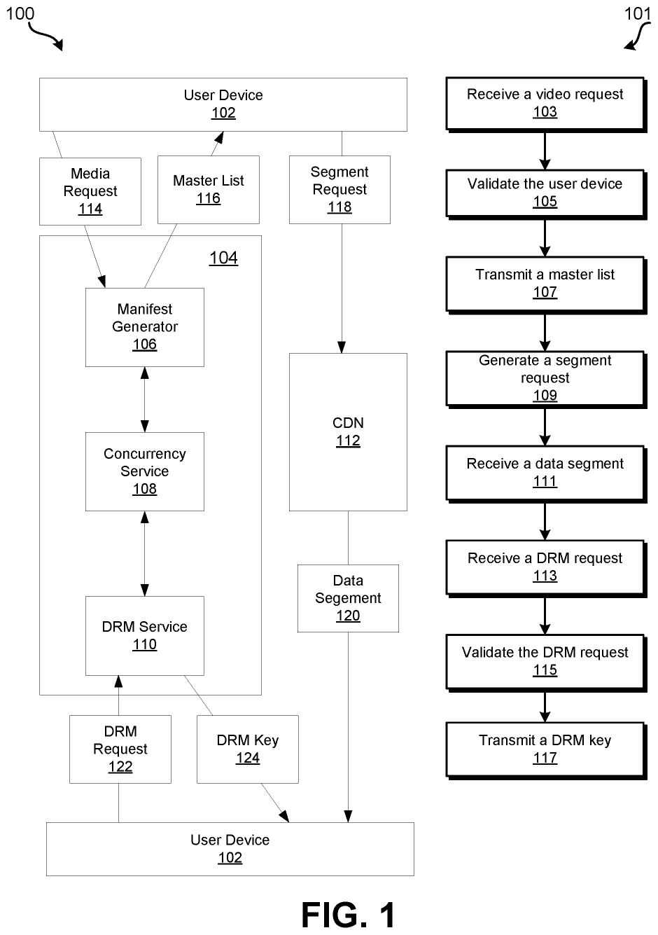

FIG. 1 illustrates a system 100 and a process 101 for validating a media file request, according to certain embodiments. The system 100 may include a user device 102 and a computing system 104. The computing system 104 may further include a manifest generator 106, a concurrency service 108, and a DRM service 110. The system 100 may also include or communicate with a CDN 112. The user device 102 may be a mobile device, tablet, computer, set top box, or any other suitable device for receiving media files and preparing the media files for display and/or playback. In some embodiments, the user device 102 may be a provider-agnostic device (e.g., a cell phone) and include an application associated with a media provider. Thus, the system 100 may be thought of as including the user device 102 and/or the data and communications passing between the user device 102 and the computing system 104 via the application. In other embodiments, the user device 102 may be a device associated with the media provider (e.g., a set top box).

The computing system 104 may include one or more virtual and/or physical machines and be associated with a media provider. The computing system 104 may be a centrally located system, or some or all of the components of the computing system 104 may be hosted in a cloud-based architecture. For example, the manifest generator 106 may be hosted on a machine (virtual or physical) in a first location, whereas the DRM service 110 may be hosted on a different machine in a second location.

The manifest generator 106 may be configured to generate one or more playlists or manifests associated with media files. For example, a user device (e.g., the user device 102) may request a streaming video of a movie. Different versions of the movie may be available to the user device 102 via the media provider (e.g., a 1080p version, a 4K version, various language versions, etc.). Each version of the movie may have respective data segments, unique to each version. In some embodiments, some versions may share some data segments. In any case, the manifest generator 106 may generate or access a playlist associated with a specific version according to a request for a particular media file (e.g., a 4K version of the movie). The manifest generator 106 may include a database or other datastore including the playlists and/or the database or other datastore may be separate from the manifest generator 106.

The concurrency service 108 may be a software and/or hardware component of the computing system 104. The concurrency service 108 may generate a log of each request for a media file received from a user device. The log may include a timestamp of when the request was generated and/or received, an identifier associated with the request (e.g., an account identifier, request identifier, etc.), an identifier associated with the user device (e.g., a MAC address, IP address, geographical information, etc.), a property of the media file(s) requested (e.g., an identifier, an associated content delivery network, etc.), and other such data. The concurrency service 108 may generate the log in a native datastore and/or an external datastore.

The concurrency service 108 may also include and/or access one or more properties associated with the media file(s). For example, the concurrency service 108 may include access policies for the requested media file(s). According to the access policies, certain account types may be permitted to access the requested media file(s) and other account types may not be permitted. Additionally or alternatively, the access policies may indicate a number of devices that can access the requested media file(s) at any given time. For example, a first account type may access the requested media file(s) from only one device, whereas a second account type may access the requested media file(s) from three devices, two devices, etc. In another example, the requested media file(s) may only be available to user devices in a particular geographical area. The examples of access policies above are merely examples; other examples of access policies would be readily apparent. Furthermore, any or all of the access policies may combined with any other access policy. The concurrency service 108 may also be configured to verify requests from the manifest generator 106 and/or the DRM service 110 against the access policies, as described below.

The DRM service 110 may process requests for DRM keys received from user devices. As described above, a user device may receive encrypted data segments of the requested media file(s) from a CDN. The user device may then request a DRM key in order to decrypt the data segment and display the media. In some embodiments, the DRM service 110 generates a unique DRM key for each data segment requested. Thus, the DRM key for one data segment may not work to decrypt any other data segment. In other embodiments, the DRM service 110 may generate a DRM key unique to the requested media file(s). Any user device that requests the DRM key for the requested media file(s) may then receive the same DRM key (after the request is validated). In yet another embodiment, the DRM service 110 may generate a DRM key associated with a particular CDN. Any media file(s) associated with the particular CDN may be decrypted using the same DRM key, whereas a media file(s) associated with a different CDN may not be decrypted. One of ordinary skill in the art would recognize many different possibilities.

According to the process 101, at 103, the computing system 103 may receive a media request 114 for a media file. The media request may be for a streaming video such as a movie, a streaming television channel, a streaming music service, or any other appropriate media type. The media request 114 may include one or more identifiers associated with the user device 102, such as a MAC address, an IP address, an account identifier (e.g., a username and/or password), geographical information associated with the user device 102, and other such information. The media request 114 may also include one or more properties associated with the media request 114 such as a timestamp indicating when the media request 114 was generated, a number of similar media requests (e.g., if a first request failed, the media request 114 may be the second media request), and other metadata associated with the media request 114. The media request 114 may be received by the manifest generator 106 and/or some other component of the computing system 104. The manifest generator 106 may determine a media file associated with the media request 114. For example, various versions of a movie may be available to the user device 102 (e.g., via an application on the user device 102). The media request 114 may then identify a specific version of the movie requested by the user device 102 (e.g., a 4K version of the movie).

At 105, the manifest generator 106 (and/or some other component of the computing system 104) may validate the media request 114 using the identifier associated with the user device 102. For example, the media request 114 may include account credentials associated with the user device 102 (and/or a user thereof). The manifest generator 106 may validate the account credentials utilizing resources associated with the media provider. The manifest generator 106 may thereby determine whether or not the user device is permitted to access the media file(s) identified in the media request 114. Additionally or alternatively, the manifest generator 106 may validate the account credentials utilizing the CDN 112. For example, the user device 102 may be permitted to access media files associated with other CDNs of the media provider. The media request 114 may identify media files associated with the CDN 112. Upon receiving the media request 114, the manifest generator 106 may determine (e.g., by communicating with the CDN 112) whether or not the user device 102 is permitted to access the media files associated with the CDN 112.

If the media request 114 is validated, the manifest generator 106 may then cause a log to be stored by the concurrency service 108. The log may include and/or identify the identifier associated with the user device (e.g., account credentials, IP address, etc.) and/or the property associated with the media request 114 (e.g., the timestamp, the number of similar requests, the media file(s) identified in the media request 114, etc.). The log may be stored perpetually, creating a permanent record of the media request 114, or the log may be stored for a predetermined time period (e.g., 1 day, 1 week, 1 month, etc.).

At 107, the manifest generator 106 may transmit a playlist 116 corresponding to the media request 114 to the user device 102. The playlist 116 may identify one or more data segments of the media file(s) identified in the media request 114. Continuing the example above, the media request 114 may identify the 4K version of the movie. The playlist 116 may therefore identify one or more data segments of the 4K version of the movie. The playlist 116 may utilize respective URLs associated with the one or more data segments, where each respective URL corresponds to a particular data segment. In some embodiments, the playlist 116 may identify various profiles corresponding to the various versions of the movie (e.g., a 1080p version, the 4K version, an 8K version, etc.). Then, the user device 102 may select a profile based on a desired version, available bandwidth, or other such factors. The respective URLs may be configured such that the respective URLs are only valid for one-time use. For example, the respective URLs may include the timestamp from the media request 114 in an encrypted format. When the respective URLs are subsequently used to request the associated data segment, the timestamp may be decrypted (e.g., by the CDN 112) and validated against a predetermined period. If the respective URL is received by the CDN 112 after the predetermined period has expired, the data segment may not be transmitted to the user device 102. Additionally or alternatively other parameters of the respective URLs may be configured to ensure that the respective URLs are one-time use. For example, a count of playlists generated for the requested media file may be encrypted within the respective URLs. The count may be the total number of requests for the media file received in perpetuity, the number of requests received that day, the number of playlists generated, etc. In this way, each respective URL for each playlist may include a unique identifier. If the CDN 112 receives multiple copies of the same respective URL, any request except the first request may be identified as an invalid request. Therefore, even if the user device 102 publishes the playlist to allow unauthorized users to access the media file(s), unauthorized requests may be identified and denied. Furthermore, because the concurrency service 108 may include a record of the user device requesting the initial media file, the source of the published playlist may be identified (e.g., the user device 102).

At 109, the user device 102 may generate a segment request 118 for a first data segment of the one or more data segments. The segment request 118 may include the respective URL associated with the first data segment, the identifier associated with the user device 102, the property associated with the media request 114 (e.g., the timestamp), and/or other relevant information. At 111, the CDN 112 may receive the segment request 118. The CDN 112 may validate the segment request 118 using the respective URL, the identifier associated with the user device 102, and/or other information included in the segment request 118. In some embodiments, the CDN 112 may validate the segment request 118 with native resources. Additionally or alternatively, the CDN 112 may validate the segment request 118 in conjunction with the computing system 104 (or components thereof, such as the concurrency service 108).

At 111, the user device 102 may receive a data segment 120. The data segment 120 may include encrypted data. The data segment 120 may correspond to the first data segment identified in the segment request 118. The encrypted data may include data needed to display a portion of the media file(s) requested in the media request 114. The encrypted data may be encrypted using an Advanced Encryption Standard (AES) algorithm (e.g., using 128-bit keys) in at least one of the Counter (CTR) or the Cipher Block Chaining (CBC) mode. The encrypted data may be encrypted using any number of proprietary DRM types. The proprietary DRM types may be associated with the media provider, the CDN 112, and/or a third party (e.g., a cloud provider). One of ordinary skill in the art would recognize many different possibilities and configurations.

At 113, the DRM service 110 may receive a DRM request 122 from the user device 102. The DRM request 122 may identify the media file from the media request 114 and/or the data segment 120. The DRM request 122 may also include the respective URL, the identifier associated with the user device 102, and other such information.

At 115, the DRM service 110 may validate the DRM request 122 in conjunction with the concurrency service 108. The DRM service 110 may transmit some or all of the DRM request 122 to the concurrency service 108. The concurrency service 108 may then check the information received from the DRM service 110 against the log corresponding to the media request 114. The concurrency service 108 may then determine whether the DRM request 122 corresponds to the media request 114. For example, the concurrency service 108 may check the time stamp included in the respective URL (or otherwise included in the DRM request 122) against the time stamp in the log. If the time stamp in the DRM request 122 matches the time stamp in the log and/or is received within the predetermined time period, the concurrency service 108 may determine that the DRM request 122 is valid. In another example, the concurrency service 108 may determine that the DRM request 122 was transmitted by a different user device than the user device 102. The concurrency service 108 may then determine whether or not multiple user devices are permitted to access the media file (or data segment) according to one or more access policies. In yet another example, the concurrency service 108 may determine whether the DRM request 122 was transmitted from the same geographical region as the media request 114. If the geographical regions are different, the DRM request 122 may be invalid. In yet another example, the concurrency service 108 may determine an account level and/or concurrent device limit associated with the user device 102 (and/or the user thereof) and then determine whether the DRM request 122 is valid.

If the concurrency service 108 validates the DRM request 122, at 117 the DRM service 110 may transmit a DRM key 124 to the user device 102. The user device 102 may then use the DRM key 124 to decrypt the data segment 120. The data segment 120 may then be rendered for display.

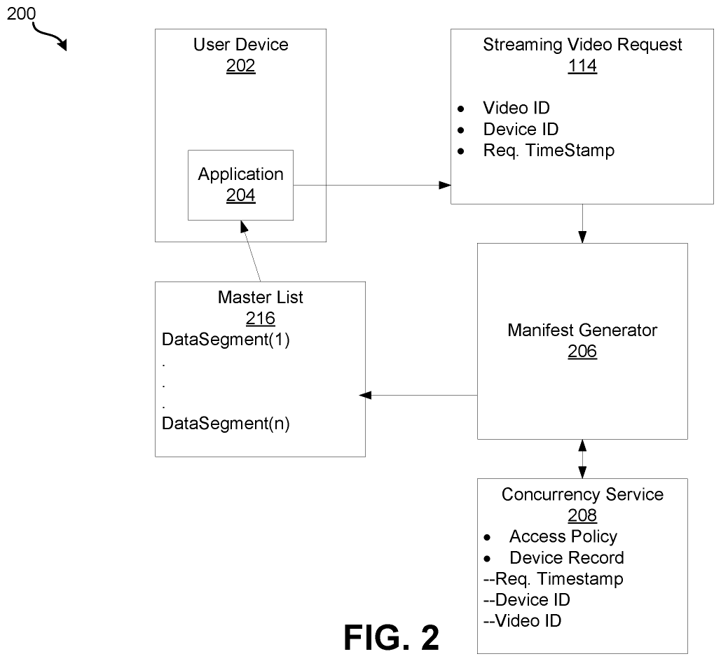

FIG. 2 illustrates a system 200 for generating a playlist 216, according to certain embodiments. The system 200 may be similar to some or all of the system 100 in FIG. 1. The system 200 may include a user device 202 including an application 204, a manifest generator 206, and a concurrency service 208. The user device 202 may be similar to the user device 102, and therefore be a mobile device, computer, set top box, or other suitable device. The application 204 may be associated with a media provider and include functionality that allows a user to request and/or view media on the user device 202 or some other connected device (e.g., a television connected to a set top box). The application 204 may communicate directly with other components associated with the media provider, such as the manifest generator 206.

The user device 202 may generate a streaming video request 214 in response to a user input via the application 204. The streaming video request 214 may include a video ID corresponding to a desired video selected by a user. For example, the application 204 may allow a user to select one or more versions of a movie (e.g., a 4K version of the movie). The video ID may then correspond to the 4K version of the video. The streaming video request 214 may also include a device ID identifying the user device 202. The device ID may include a MAC address, an IP address, account credentials associated with a user of the user device 202, and/or other such information. The streaming video request 214 may also include a request timestamp, indicating a time that the streaming video request 214 was generated.

The manifest generator 206 may receive the streaming video request 214 from the user device 202 and/or the application 204. The manifest generator 206 may validate streaming video request 214. For example, the manifest generator may validate some or all of the device ID (e.g., the account credentials) utilizing resources associated with the media provider. The manifest generator 206 may thereby determine whether or not the user device 202 is permitted to access a media file(s) identified in the streaming video request 214 by the video ID. Additionally or alternatively, the manifest generator 206 may validate the account credentials utilizing a CDN associated with the media file(s). For example, the user device 202 may be permitted to access media files associated with other CDNs of the media provider.

The manifest generator 206 may then transmit some or all of the streaming video request 214 to the concurrency service 208. The concurrency service 208 may include access policies associated with the media provider (e.g., account levels), the user device 202 (e.g., a concurrent device limit), and or the CDN (e.g., a geographical policy). In response to receiving the streaming video request 214, the concurrency service 208 may create (or update) a device record associated with the user device 202. The device record may then include the request timestamp, the device ID, the video ID, and/or any other relevant information. The device record may be stored by the concurrency service 208 in perpetuity or for some predetermined period (e.g., 1 hour, 1 day, 1 week, etc.).

The manifest generator 206 may then create or access a playlist 216 and transmit the playlist 216 to the user device 202 and/or the application 204. The playlist 216 may identify one or more data segments that include portions of the media identified in the streaming video request 214 (e.g., the 4K version of the movie). In some embodiments, the playlist 216 may identify various profiles corresponding to the various versions of the movie (e.g., a 1080p version, the 4K version, an 8K version, etc.). Then, the user device 202 and/or the application 204 may select a profile based on a desired version, available bandwidth, or other such factors. The manifest generator 206 may generate a respective URL for each of the data segments 1-n included in the playlist 216. The respective URLs may be configured such that the respective URLs are only valid for one-time use. For example, the respective URLs may include the request timestamp from the media in an encrypted format. When the respective URLs are subsequently used to request the associated data segment, the request timestamp may be decrypted and validated against a predetermined period. If the respective URL is received after the predetermined period has expired, the data segment may not be transmitted to the user device 202. Additionally or alternatively other parameters of the respective URLs may be configured to ensure that the respective URLs are one-time use. For example, a count of playlists generated for the requested media file may be encrypted within the respective URLs. The count may be the total number of requests for the media file received in perpetuity, the number of request received that day, the number of playlists generated, etc. In this way, each respective URL for each playlist may include a unique identifier. If multiple copies of the same respective URL are received, any request except the first request may be identified as an invalid request. Therefore, even if the user device 202 publishes the playlist to allow unauthorized users to access the media file(s), unauthorized requests may be identified and denied. Furthermore, because the concurrency service 208 may include a record of the user device requesting the initial media file, the source of the published playlist may be identified.

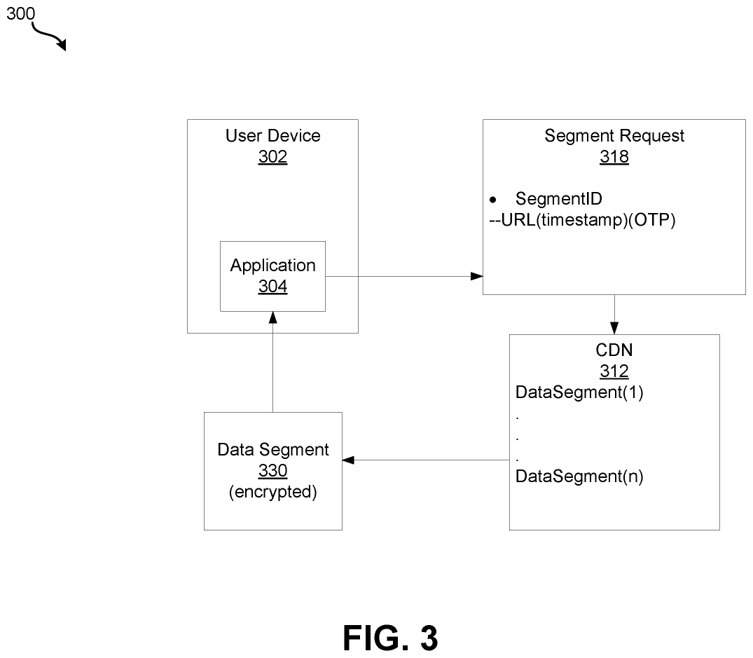

FIG. 3 illustrates a system 300 for receiving a data segment 330, according to certain embodiments. The system 300 may be similar to some or all of the system 100 in FIG. 1, and/or may work in conjunction with the system 200 in FIG. 2. The system 300 may include a user device 302, including an application 304, and a CDN 312. The user device 302 and the application 304 may correspond to the user device 202 and the application 204 in FIG. 2 and have similar characteristics and functionalities. The CDN 312 may be similar to the CDN 112 in FIG. 1. The CDN 312 may be associated with the media file identified in a streaming video request such as the streaming video request 214. The CDN 312 may be associated with the media provider, or may be a separate entity.

Continuing the example from FIG. 2, the user device 302 and/or the application 304 may generate segment request 318 based at least in part on the playlist 216. The segment request 318 may include a segment ID corresponding to one of the data segments 1-n included in the playlist 216. For example, the segment request 318 may identify the data segment(1) (being the first data segment of the streaming video identified in the playlist 216). The segment request 318 may also include the respective URL associated with the data segment(1). As described above, the respective URL may include the time stamp and/or some other element configured such that the respective URL is a one-time use URL.

The segment request 318 may be received by the CDN 312. The CDN 312 may include (or access) the data segments 1-n in encrypted format. In some embodiments, the CDN 312 may validate the segment request 318, as is described in relation to FIG. 1. In other embodiments, the CDN 312 may simply transmit the data segment 330 in the encrypted format to the user device 302 and/or the application 304. The data segment 330 may be encrypted using an Advanced Encryption Standard (AES) algorithm (e.g., using 128-bit keys) in at least one of the Counter (CTR) or the Cipher Block Chaining (CBC) mode. The encrypted data may be encrypted using any number of proprietary DRM types. The proprietary DRM types may be associated with the media provider, the CDN 312, and/or a third party (e.g., a cloud provider). One of ordinary skill in the art would recognize many different possibilities and configurations.

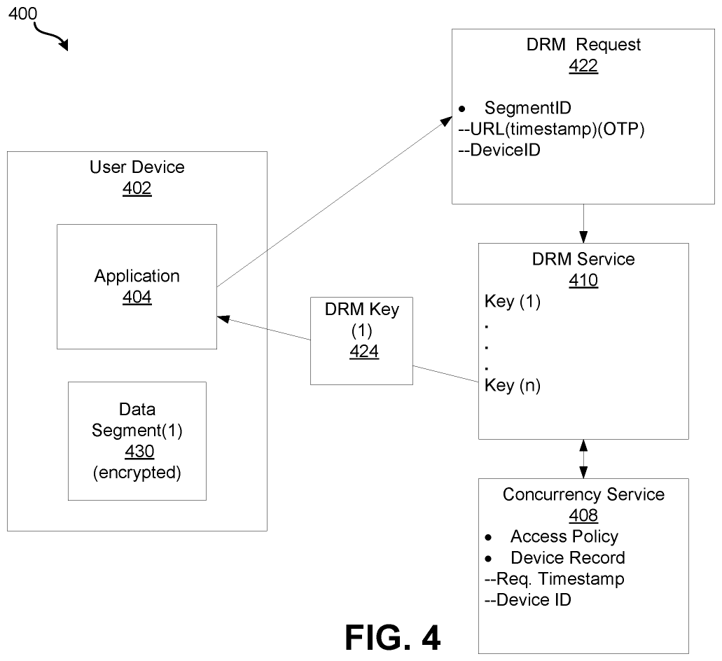

FIG. 4 illustrates a system 400 for providing a DRM key 424, according to certain embodiments. The system 400 may be part of the system 100, described in relation to FIG. 1. The system 400 may operate alone or in conjunction with other systems, such as the systems 200 and 300 in FIGS. 2 and 3, respectively. The system 400 may include a user device 402 with an application 404, a concurrency service 408, and a DRM service 410. The user device 402, application 404, and the concurrency service 408 may correspond to the user device 202, the application 204, and concurrency service 208 in FIG. 2, having similar characteristics and functionalities. The DRM service 410 may be similar to the DRM service 110 in FIG. 1, and include similar functionalities. The DRM service 410 may be associated with the media provider, the CDN (e.g., the CDN 312 in FIG. 3), and/or a third party.

Continuing the example from FIG. 3, the user device 402 may include data segment 40 (corresponding to the data segment 330) in encrypted format. The application 404 and/or the user device 402 may generate and transmit a DRM request 422. The DRM request 422 may include a segment ID, identifying the data segment(1) included in the data segment 430. The DRM request 422 may also include the respective URL associated with the data segment(1). The respective URL may include the request timestamp from the streaming video request 214 and/or a time stamp indicating when the DRM request 422 was generated. The respective URL may additionally or alternatively include other elements such that the respective URL is a one-time use URL (as is described in relation to FIG. 1). The DRM request 422 may also include a device ID indicating the user device 402 as the originator of the DRM request 422.

The DRM service 410 may receive the DRM request 422 and validate the DRM request 422. To do so, the DRM service 410 may transmit some or all of the DRM request 422 to the concurrency service 408. The concurrency service 408 may then check the information received from the DRM service 410 against the log corresponding to the streaming video request 214 and/or the access policy(ies). The concurrency service 408 may then determine whether the DRM request 422 corresponds to the streaming video request 214. For example, the concurrency service 408 may check the time stamp included in the respective URL (or otherwise included in the DRM request 422) against the time stamp in the device record (sometimes, the “log”). If the time stamp in the DRM request 422 matches the request time stamp in the log and/or is received within the predetermined time period, the concurrency service 408 may determine that the DRM request 422 is valid. The predetermined time period may be five minutes. If the difference between the request timestamp in the log and the time stand included in the DRM request 422 is less than five minutes, the concurrency service 408 may indicate that the DRM request 422 is valid. Conversely, if the difference is an hour, the concurrency service 408 may indicate that the DRM request 422 is invalid.

In another example, the concurrency service 408 may determine that the DRM request 422 was transmitted by a different user device than the user device 402 by comparing the device ID in the DRM request 422 to the device ID in the log (or device record). The concurrency service 408 may then determine whether or not multiple user devices are permitted to access the media file (or data segment) according to one or more access policies. In yet another example, the concurrency service 408 may determine whether the DRM request 422 was transmitted from the same geographical region as the streaming video request 214. If the geographical regions are different, the DRM request 422 may be invalid. In yet another example, the concurrency service 408 may determine an account level and/or concurrent device limit associated with the user device 402 (and/or the user thereof) and then determine whether the DRM request 422 is valid.

In response to determining that the DRM request 422 is valid, the DRM service 410 may provide the DRM key 424 to the user device 402 and/or the application 404. The DRM key 424 may correspond to the data segment 430 (e.g., data segment(1)). Thus, system 400 may validate every DRM request for every data segment included in the playlist 216 when the user device 402 requests a corresponding DRM key. In other embodiments, the DRM key 424 may be used for each data segment in the playlist 216, be valid for a given amount of time (e.g., 3 hours), be used for any media file provided by the CDN 312, or any combination thereof. One of ordinary skill in the art would recognize many different possibilities and configurations.

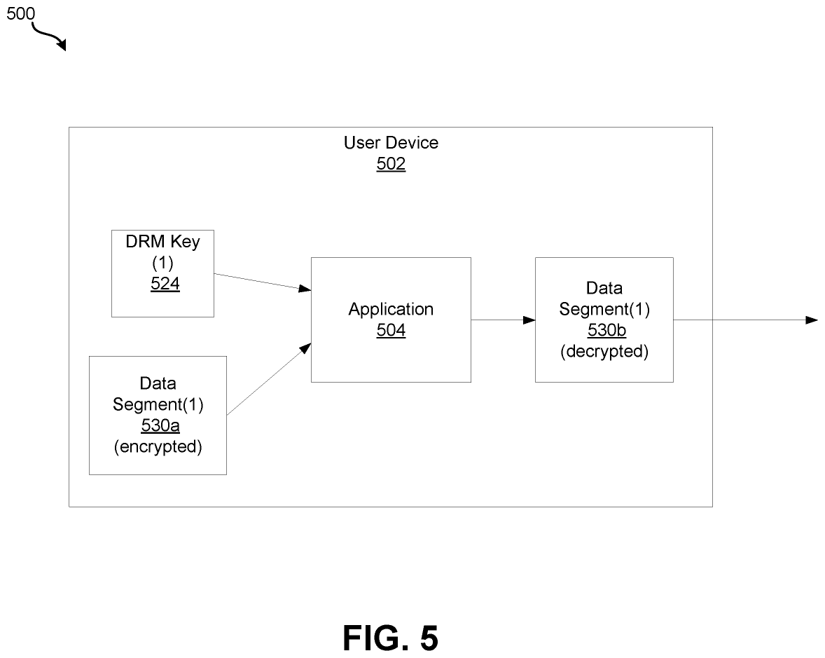

FIG. 5 illustrates a system 500 for decrypting a data segment 530a, according to certain embodiments. The system 500 may be a part of the system 100 in FIG. 1. The system 500 may operate alone or in conjunction with other systems, such as the systems 200, 300, and 400 in FIGS. 2, 3, and 4, respectively. The system 500 may include a user device 502 with an application 504. The user device 502 and the application 504 may correspond to the user device 202 and the application 204 in FIG. 2 and have similar characteristics and functionalities.

Continuing the example from FIG. 4, the user device 502 may include a DRM key 524 and a data segment 530a, corresponding to the DRM key 424 and the data segment 430 in FIG. 4. The application 504 may utilize the DRM key 524 to decrypt the data segment 530a to generate data segment 530b. The data segment 530b may be in decrypted format, such that the data segment 530b may be rendered for display. The data segment 530b may be rendered by the application 504 or by some other component of the user device 502. Once rendered, media corresponding to the data segment 530b may be displayed by the user device 502 and/or by another device connected to the user device 502. For example, the user device 502 may be a set top box connected to a television. The user device 502 may then render the data segment 530b and output data to the television for display.

The user device 502 may then repeat the processes described in relation to FIGS. 1-5 for a next data segment. Thus, the user device 502 may render data segments until the media file(s) corresponding to the playlist 216 has been displayed (or rendered). By using the systems and techniques described above, the media file(s) indicated in the streaming video request 214 may be better protected, with multiple validations reducing the risk of unauthorized access to the media file(s) and/or DRM keys.

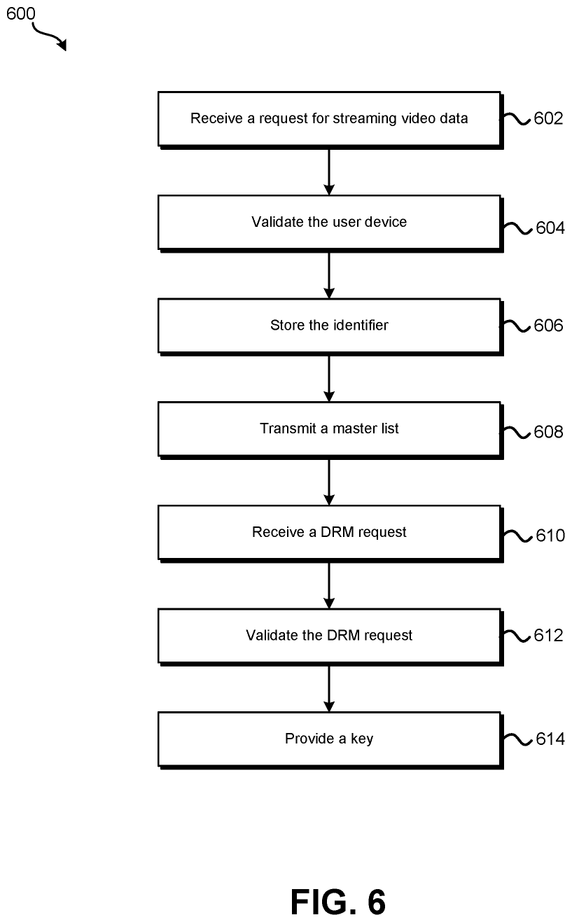

FIG. 6 illustrates a flowchart of a method 600 for validating a streaming video request, according to certain embodiments. The method 600 may be performed by some or all of the systems 100-500 working alone or in conjunction with one another. The steps of the method 600 may be performed in a different order than is described and shown, and/or the steps may be combined with other steps. In some embodiments, some steps may be skipped altogether.

At step 602, the method 600 may include receiving, by a computing system, a request for streaming video data from a user device. The computing system may be similar to the computing system 104 in FIG. 1. The user device may be similar to the user device 202 and the request similar to the streaming video request 214 in FIG. 2. The request may include a video ID corresponding to a desired video selected by a user. The request may also include a device ID identifying the user device. The device ID may include a MAC address, an IP address, account credentials associated with a user of the user device, and/or other such information. The request may also include a request timestamp, indicating a time that the streaming video request was generated.

At step 604, the method 600 may include validating, by the computing system, the request utilizing the identifier associated with the user device. The computing system may validate request using a manifest generator (e.g., the manifest generator 206 in FIG. 2) and/or some other component. For example, the manifest generator may validate some or all of the device ID (e.g., the account credentials) utilizing resources associated with a media provider. The manifest generator may thereby determine whether or not the user device is permitted to access a media file(s) identified in the request. Additionally or alternatively, the manifest generator may validate the account credentials utilizing a CDN associated with the media file(s).

At step 606, the method 600 may include storing, by the computing system, the identifier associated with the user device, a property associated with the request for the streaming video data, or any combination thereof. For example, the computing system may include a concurrency service (e.g., the concurrency service 208). Then, the computing system may provide some or all of the information included in the request to the concurrency service. The concurrency service may include access policies associated with the media provider (e.g., account levels), the user device (e.g., a concurrent device limit), and or the CDN (e.g., a geographical policy). In response to receiving the request, the concurrency service may create (or update) a device record associated with the user device. The device record may then include the request timestamp, the device ID, the video ID, and/or any other relevant information. The device record may be stored by the concurrency service in perpetuity or for some predetermined period (e.g., 1 hour, 1 day, 1 week, etc.).

In response to validating the user device, at step 608, the method 600 may include transmitting, by the computing system, a playlist of the to the user device. The playlist may identify one or more data segments of the streaming video data. The playlist may be generated by the manifest generator as described in relation to FIG. 2. The manifest generator may create or access the playlist and transmit the playlist to the user device. The playlist may identify one or more data segments that include portions of the media identified in the streaming video request (e.g., the 4K version of the movie). In some embodiments, the playlist may identify various profiles corresponding to the various versions of the movie (e.g., a 1080p version, the 4K version, an 8K version, etc.). Then, the user device may select a profile based on a desired version, available bandwidth, or other such factors. The manifest generator may generate a respective URL for each of the data segments 1-n included in the playlist. The respective URLs may be configured such that the respective URLs are only valid for one-time use.

At step 610, the method 600 may include receiving, by the computing system, a DRM request. The DRM request may include the identifier associated with the user device and an identifier corresponding to a first data segment of the one or more data segments of the playlist. For example, The DRM request may include a segment ID corresponding to the first data segment. The DRM request may also include the respective URL associated with the first data segment. The respective URL may include the request timestamp from the request and/or a time stamp indicating when the DRM request was generated. The respective URL may additionally or alternatively include other elements such that the respective URL is a one-time use URL (as is described in relation to FIG. 1). The DRM request may also include a device ID (e.g., an IP address) indicating the user device as the originator of the DRM request.

At step 612, the method 600 may include validating, by the computing system, the DRM request based at least in part on the identifier associated with the user device, the request for streaming video data, the identifier corresponding to the first data segment, or any combination thereof. For example, The DRM request may be validated by the manifest generator and/or the concurrency service working alone or in conjunction with each other, as is described in relation to FIG. 4.

In response to validating the DRM request, at step 614, the method 600 may include providing, by the computing system, a key to the user device such that the user device can decrypt the first data segment. The key may be similar to the DRM key 424 in FIG. 4. The user device may decrypt the first data segment as is described in relation to FIG. 5.

In some embodiments, the method 600 may include receiving, by the computing system, a second DRM request. The second DRM request may include the identifier associated with the user device and an identifier corresponding to a second data segment of the one or more data segments of the playlist. The method 600 may then include validating, by the computing system, the second DRM request based at least in part on the identifier associated with the user device, the request for streaming video data, the identifier corresponding to the second data segment, or any combination thereof. In response to validating the DRM request, the method 600 may then include providing, by the computing system, a second key to the user device such that the user device can decrypt the second data segment.

In some embodiments, the method 600 may include receiving, by the computing system, a second request for the streaming video data. The second request may include the identifier associated with the user device. The method 600 may then include determining, by the computing system, that the second request is invalid based at least in part on the identifier associated with the user device, the property associated with the request for the streaming video data, or any combination thereof. The method 600 may then include transmitting, by the computing system, a failure message to a sender of the second request for the streaming video data. In some embodiments, an original requestor of the m

[symbol]

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks. For example, executing instructions stored in the non-transitory computer-readable medium causes the processors to perform steps of methods and/or to implement features of components described herein.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of steps may be undertaken before, during, or after the above elements are considered.

What is claimed is:

1. A method of validating a streaming video request, comprising:
receiving, by a computing system, a request for streaming video data from a user device, the request comprising an identifier associated with the user device;
validating, by the computing system, the request utilizing the identifier associated with the user device;
storing, by the computing system, the identifier associated with the user device, a property associated with the request for the streaming video data, or any combination thereof;
in response to validating the user device:
transmitting, by the computing system, a playlist to the user device, the playlist identifying one or more data segments of the streaming video data;
receiving, by the computing system, a digital rights management (DRM) request, the DRM request comprising the identifier associated with the user device and an identifier corresponding to a first data segment of the one or more data segments of the playlist;
validating, by the computing system, the DRM request based at least in part on the identifier associated with the user device, the request for streaming video data, the identifier corresponding to the first data segment, or any combination thereof; and
in response to validating the DRM request:
providing, by the computing system, a key to the user device such that the user device may decrypt the first data segment.

2. The method of claim 1, wherein the identifier corresponding to the first data segment comprises a uniform resource locator (URL), the URL configured to be a one-time use URL.

3. The method of claim 1, wherein the identifier corresponding to the respective portion of the data comprises a uniform resource locator (URL), wherein the URL comprises a timestamp indicating a time a request the first data segment was transmitted.

4. The method of claim 1, wherein the property associated with the streaming video data comprises an access policy associated with the data based on at least one of geographical data, an account level, or a concurrent device limit.

5. The method of claim 4, wherein the property associated with the request for the streaming video data comprises a timestamp indicating a time the request was transmitted.

6. The method of claim 1, wherein the identifier associated with the user device include at least one of an IP address or a MAC address.

7. The method of claim 1, further comprising:
receiving, by the computing system, a second DRM request, the second DRM request comprising the identifier associated with the user device and an identifier corresponding to a second data segment of the one or more data segments of the playlist;
validating, by the computing system, the second DRM request based at least in part on the identifier associated with the user device, the request for streaming video data, the identifier corresponding to the second data segment, or any combination thereof; and
in response to validating the DRM request:
providing, by the computing system, a second key to the user device such that the user device may decrypt the second data segment.

8. The method of claim 1, wherein the DRM request comprises a URL and the identifier associated with the user device is comprised in a header of the DRM request.

9. The method of claim 1, further comprising:
receiving, by the computing system, a second request for the streaming video data, the second request comprising the identifier associated with the user device;
determining, by the computing system, that the second request is invalid based at least in part on the identifier associated with the user device, the property associated with the request for the streaming video data, the property associated with the streaming video data, or any combination thereof; and
transmitting, by the computing system, a failure message to a sender of the second request for the streaming video data.

10. A system, comprising:
a manifest generator configured to generate a playlist of one or more data segments, the playlist of data segments comprising a respective URL for each of the one or more data segments, wherein each of the one or more data segments comprise a portion of streaming video data;
a concurrency service comprising one or more access policies associated with the one or more data segments;
a digital rights management (DRM) service configured to generate keys to decrypt one or more of the one or more data segments;
one or more processors; and
a non-transitory computer readable memory comprising instructions that, when executed by the one or more processors, cause the system to perform operations to:
receive, by the manifest generator, a request for streaming video data from a user device, the request comprising an identifier associated with the user device;
validate, by at least one of the manifest generator or the concurrency service. the request utilizing the identifier associated with the user device;
store, by the concurrency service, the identifier associated with the user device, a property associated with the request for the streaming video data, or any combination thereof;
in response to validating the user device:
transmit, by the manifest generator, a playlist to the user device, the playlist identifying the one or more data segments of the streaming video data;
receive, by the DRM service, a DRM request, the DRM request comprising the identifier associated with the user device and an identifier corresponding to a first data segment of the one or more data segments of the playlist;
validate, by at least one of the DRM service or the concurrency service, the DRM request based at least in part on the identifier associated with the user device, the request for streaming video data, the identifier corresponding to the first data segment, or any combination thereof; and
in response to validating the DRM request:
provide a key to the user device such that the user device may decrypt the first data segment.

11. The system of claim 10, wherein the DRM service is associated with at least one of a media provider, a content provider, or a third-party.

12. The system of claim 10, wherein the identifier corresponding to the first data segment comprises a uniform resource locator (URL), the URL configured to be a one-time use URL.

13. The system of claim 12, wherein the URL comprises an encrypted count such that the URL is unique.

14. The system of claim 10, wherein the key is associated with the first data segment.

15. The system of claim 10, wherein the key is associated with a plurality of data segments, the plurality of data segments comprising the first data segment.

16. The system of claim 10, wherein the DRM request comprises a URL and the identifier associated with the user device is comprised in a header of the DRM request.

17. The system of claim 10, wherein the identifier associated with the user device include at least one of an IP address or a MAC address.

18. A non-transitory computer-readable medium comprising instructions that, when executed by one or more processors, cause the one or more processors to perform operations comprising:
receiving, by a computing system, a request for streaming video data from a user device, the request comprising an identifier associated with the user device;
validating, by the computing system, the request utilizing the identifier associated with the user device;
storing, by the computing system, the identifier associated with the user device, a property associated with the request for the streaming video data, or any combination thereof;
in response to validating the user device:
transmitting, by the computing system, a playlist to the user device, the playlist identifying one or more data segments of the streaming video data;
receiving, by the computing system, a digital rights management (DRM) request, the DRM request comprising the identifier associated with the user device and an identifier corresponding to a first data segment of the one or more data segments of the playlist;
validating, by the computing system, the DRM request based at least in part on the identifier associated with the user device, the request for streaming video data, the identifier corresponding to the first data segment, or any combination thereof; and
in response to validating the DRM request:
providing, by the computing system, a key to the user device such that the user device may decrypt the first data segment.

19. The non-transitory computer-readable medium of claim 18, wherein the key is associated with the first data segment.

20. The non-transitory computer-readable medium of claim 18, wherein the key is associated with a plurality of data segments, the plurality of data segments comprising the first data segment.
